(19) United States
(12) Patent Application Publication
(10) Pub. No.: US 2002/0069861 A1
(43) Pub. Date: Jun. 13, 2002

(54) EGR system

(76) Inventor: Noboru Sakamoto, Iwata-shi (JP)

Correspondence Address: ERNEST A. BEUTLER, ATTORNEY AT LAW, 500 NEWPORT CENTER DRIVE, SUITE 945, NEWPORT BEACH, CA, 92660, US

(21) Appl. No.: 09/683,184

(22) Filed: Nov. 29, 2001

(30) Foreign Application Priority Data
Dec. 8, 2000 (JP) 2000-374336

(51) Int. Cl. F02M 33/02

(52) U.S. Cl. 123/568.17; 123/568.18; 123/518

(57) ABSTRACT

An improved engine emission control for controlling both nitrous oxide emissions through an exhaust gas recirculation system and evaporative fuel emissions. These gases (exhaust and evaporated fuel) are mixed with the intake charge in a mixing chamber that surrounds the intake passage so as to insure good mixing at an upstream point removed from the combustion chambers so that a uniform mixture will be delivered to each chamber and there will be uniformity in the added mixture between the chambers.

### BACKGROUND OF INVENTION

This invention relates to an internal combustion engine and more particularly to an improved system for preventing the emission of unwanted gases to the atmosphere including nitrous oxides (NO_{X}) and evaporated fuel emissions.

In internal combustion engines in an effort to improve performance and reduce the emission of unwanted exhaust gases constituents, it has been proposed to utilize a system for recirculating exhaust gases (EGR) to the combustion chamber. By returning some of the exhaust gases to the combustion chamber, the temperature in the combustion chamber can be reduced and the emission of objectionable nitrous oxides can be reduced. Generally, the flow of these exhaust gases is controlled by an EGR valve depending upon engine performance and the exhaust gases are introduced into the intake system somewhere between the air inlet and the combustion chambers.

It has been found, however that conventional systems do not provide the desired operation because the exhaust gases may be delivered unevenly to the combustion chambers of the engine and/or not thoroughly mixed with the intake air so that their optimum performance can be achieved. In addition, this type of system can cause unequal distribution from cylinder to cylinder as well as variations within the cylinder, which also contribute to unstable running and unstable combustion.

It is, therefore, a principle object to this invention to provide an improved EGR system wherein the exhaust gases are well mixed with the charge that is delivered to the combustion chambers so as to eliminate the aforenoted problems.

A similar situation deals with the treatment of evaporative vapors from the fuel, primarily those that accumulate in the fuel tank above the fuel as the fuel level depletes. It has been proposed to employ a carbon canister or canisters containing other materials that will absorb the fuel vapors. These fuel vapors are then periodically delivered to the engine induction system for combustion therein so that the raw fuel is not discharged to the atmosphere.

The same distribution problems and homogeneous mixture problems as are present with the exhaust gas recirculation system are also true with these evaporative fuel emission systems.

It is, therefore, a still further object to this invention to provide an improved evaporative fuel emission control system for an engine.

It is a yet further object to this invention to provide an improved arrangement for mixing both exhaust recirculating gas systems and evaporative emission control systems that combines the products and mixes them well with the intake air charge.

### SUMMARY OF INVENTION

The features of this invention are adapted to be embodied in an internal combustion engine that has at least one combustion chamber and an induction system for delivering an air charge to the combustion chamber. The induction system includes at least one generally cylindrical conduit portion.

In accordance with a first feature of the invention, the engine includes an exhaust system for delivering combustion products from the combustion chamber to the atmosphere. An exhaust gas recirculating system recirculates a portion of the combustion products back to the combustion chamber. This exhaust gas recirculating system includes a mixing chamber encircling at least a portion of the induction system generally circular conduit portion. A plurality of circumferentially spaced apertures are provided in the induction system generally cylindrical conduit portion for communicating the mixing chamber with the interior of the induction system generally cylindrical conduit portion. An exhaust gas re-circulating conduit communicates the exhaust system with the mixing chamber.

A second feature of the invention is adapted in an engine as set forth in the first paragraph of this section and that includes a fuel system for delivering fuel to the engine for combustion in the combustion chamber. An evaporative fuel control system is provided for preventing the emission of evaporated fuel from the fuel system to the atmosphere. The evaporative fuel control system includes a mixing chamber that encircles at least a portion of the induction system generally cylindrical conduit portion. A plurality of circumferential spaced apertures are formed in the induction system generally circular conduit portion for communicating the mixing chamber with the interior of the induction system generally cylindrical conduit portion. An evaporative fuel control conduit communicates the evaporative fuel control system with the mixing chamber.

### BRIEF DESCRIPTION OF DRAWINGS

FIG. 1 is an end elevational view of an internal combustion engine constructed in accordance with an embodiment of the invention.

FIG. 2 is a view of the engine as shown in FIG. 1 but looking from the opposite end thereof.

FIG. 3 is an enlarged cross sectional view taken along the line 3-3 of FIG. 2 and showing the relative position of the throttle valve so that its axis can be related to the remaining components.

### DETAILED DESCRIPTION

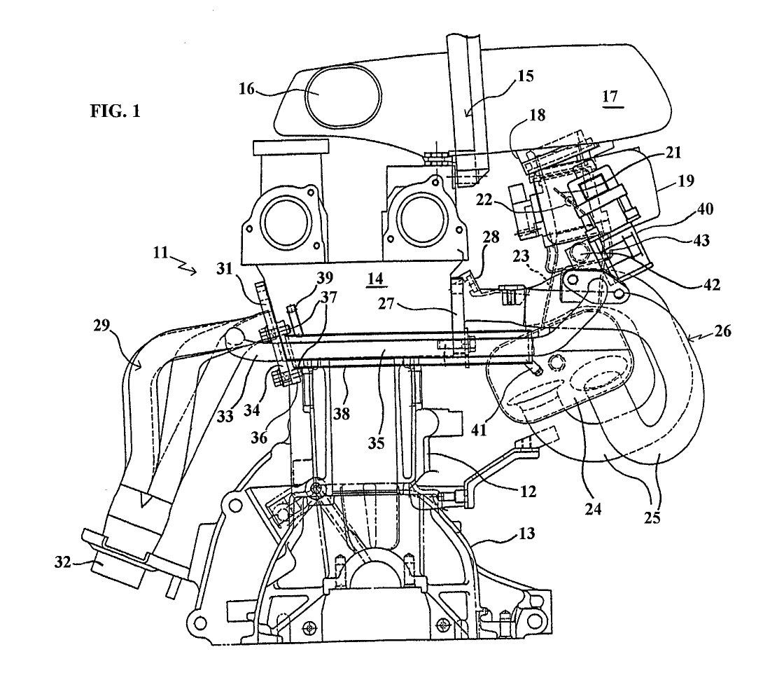

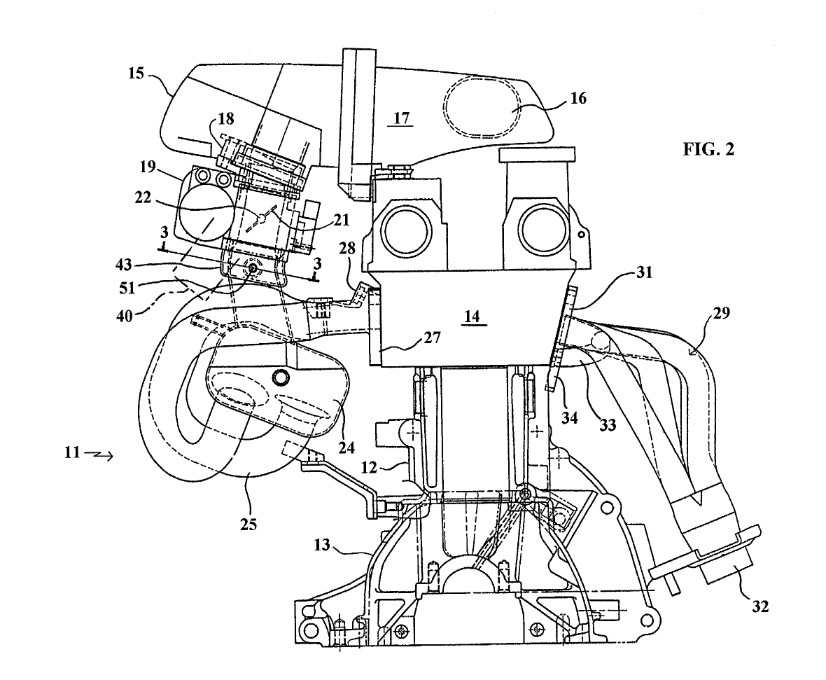

An internal combustion engine constructed in accordance with an embodiment of the invention is identified generally by the reference numeral 11 and is shown only partially. That is, the illustrations in FIGS. 1 and 2 shows only the portion of the engine above the crankcase because the invention deals primarily with the emission control systems for the engine rather than the internal mechanical components of the engine. It is believed that from the following description, those skilled in the art will be readily able to understand and practice the invention without knowing more of the internal details of the engine which can be employed with a wide variety of engines.

The engine 11 is comprised of a cylinder block 12 having an upper crankcase portion 13 in which its crankshaft is rotatably journalled in a known manner. The lower end of the crankcase is not shown for the aforenoted reasons.

The cylinder block 12 forms a plurality of combustion chambers along with a cylinder head 14 that is affixed thereto and with pistons that reciprocate in the cylinder bores of the cylinder block. Again, the number of cylinders and the arrangement in the cylinder block may be of any suitable type.

An induction system is provided for delivering an air charge to these combustion chambers. This induction system includes generally an air inlet device, indicated generally by the reference numeral 15 and which includes an atmospheric air opening 16 into which atmospheric air is inducted. A plenum chamber 17 is formed within this inlet device 15 and a suitable filtration element is interposed between the inlet 16 and an outlet portion 18.

This outlet portion 18 communicates with a throttle body 19 in which a butterfly type throttle valve 21 is rotatably journalled on a throttle valve shaft 22. This throttle valve 21 is controlled in any suitable manner.

The throttle body 19 has a generally cylindrical outlet conduit 23, which, in turn, communicates with a further intake system plenum chamber 24. This further plenum chamber 24 serves individual runner pipes 25 of an intake manifold, indicated generally by the reference numeral 26, and which may have a number of runners 25 equal to the number of the cylinders in the cylinder block 12. Not all of these conduits are illustrated in the figures. These runners 25 are connected to a manifold flange 27 that is suitably affixed to the inlet side of the cylinder head 14.

The cylinder head 14 is provided with suitable intake passages and valve mechanism for delivering the air charge to the combustion chambers. This may include one or a plurality of intake valves operated in any desired manner.

In addition, a fuel supply system is provided for delivering fuel to the combustion chambers for mixture with the air and combustion in the combustion chambers. This fuel supply system includes a remotely positioned fuel tank (not shown) and suitable supply conduits that deliver fuel to fuel injectors, which are not shown, but which are received in suitable receptacle openings 28 formed in the manifold flange 27 or in the cylinder head 14. This fuel supply system also includes an evaporative emission system that includes a canister (not shown) that communicates with the area above the fuel in the fuel tank and delivers it to the induction system for mixing with the intake air in a manner, which will be described shortly.

The fuel air mixture, which has been delivered to the combustion chambers of the engine, is ignited in a suitable manner i.e. by spark plugs in the event the engine 11 is a spark ignited engine. The exhaust gases are then delivered to the atmosphere through an exhaust manifold, indicated generally by the reference numeral 29. This exhaust manifold 29 has a plurality of runners that are integrally connected to an exhaust flange 31 that is fixed to the side of the cylinder head 14 opposite the intake manifold flange 27. These individual runners have a common outlet 32 that communicates with a suitable exhaust system (not shown).

In order to reduce the amount of nitrous oxides formed in the combustion chambers and delivered to the atmosphere, an EGR system is employed. This includes an EGR conduit that comprised of a pick up tube 33 that communicates with the exhaust manifold 29 and which has an outlet end in a fitting portion 34 of the manifold flange 31.

An EGR cooler, indicated generally by the reference numeral 35 is connected to this flange 31 by a flange 36 and threaded fasteners 37. This EGR cooler 35 has a double wall construction that is comprised of an inner tube through which the exhaust gases pass and an outer tube 38 that defines a cooling jacket around this inner tube. A coolant inlet 39 is provided at one end of this cooling jacket and receives coolant from the engine cooling system. A coolant discharge 41 at the other end of the EGR cooler 35 discharges the coolant back into the engine cooling system.

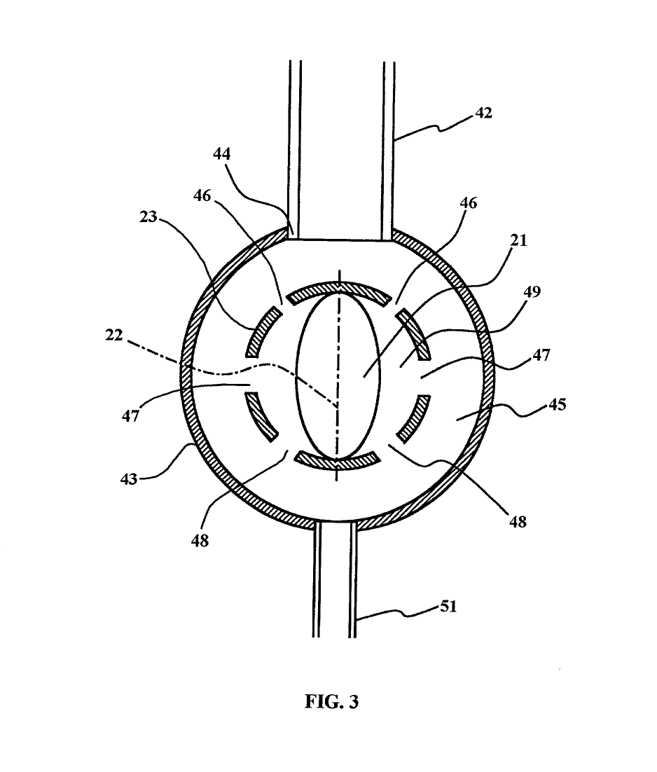

The amount of recirculated exhaust gasses is controlled by an EGR valve 40 that operates on any desires strategy and to which the cooled exhaust gases are delivered to by a fitting of the cooler 35. The EGR valve 40 has a flange portion 42 that is suitably attached to an outer shell 43 of a mixing chamber, which surrounds a generally cylindrical portion of the throttle body outlet or intake manifold inlet 23 as best seen in FIG. 3. The connection between the EGR valve flange portion 42 and the mixing chamber outer shell 43 is shown schematically at 44 in this figure.

As may be seen, there is a fairly substantial cylindrical area 45, which surrounds the outer wall of the inlet section 23. The inlet section 23 is provided with a plurality of circumferentially spaced openings 46, 47 and 48 that are spaced circumferentially around the center of the intake manifold conduit 23. The openings 46, 47 and 48 are progressively larger in cross sectional area in the flow direction from the fitting 44 to the opposite sides so as to insure equal flow from them into the interior of the intake passage 23.

In addition, these openings are disposed so that they are not parallel to the access of the throttle valve shaft 23, which is shown in broken lines in this figure. This further insures that there will be good mixing.

In addition to mixing the exhaust gases in the mixing chamber 45, an outlet 52 from the evaporative fuel canister also enters into this mixing chamber 45 50 as to insure good mixing of the evaporative fuel vapors with the intake air charge.

Since this device is positioned immediately adjacent and downstream of the throttle valve 22 it will have sufficient distance also to travel before it reaches the individual combustion chambers and will pass through the plenum chamber 24 to further insure good missing and uniform distribution.

Thus, from the foregoing description, it should be readily apparent that the described construction provides very good emission control by utilizing the mixing chamber that communicates with the intake system and which receives both exhaust gases for EGR control and evaporated fuel for evaporative fuel emission control. Of course, the foregoing description is that of a preferred embodiment of the invention and various changes and modifications may be made without departing from the spirit and scope of the invention, as defined by the appended claims.

1. An internal combustion engine comprised of an engine body defining at least one combustion chamber, an induction system for delivering at least an air charge to said combustion chamber, said induction system including at least one generally cylindrical conduit portion, an exhaust system for discharging combustion products from said combustion chamber to the atmosphere, and an exhaust gas re-circulating system for re-circulating a portion of said combustion products back to said combustion chamber, said exhaust gas re-circulating system including a mixing chamber encircling at least a portion of said induction system generally cylindrical conduit portion, a plurality of circumferentially spaced apertures in said induction system generally cylindrical conduit portion communicating said mixing chamber with the interior of said induction system generally cylindrical conduit portion and an exhaust gas re-circulating conduit communicating said exhaust system with said mixing chamber.

2. An internal combustion engine as set forth in claim 1, wherein the induction system includes at least one throttle valve for controlling flow and the mixing chamber is juxtaposed to said throttle valve.

3. An internal combustion engine as set forth in claim 3, wherein the mixing chamber is disposed downstream of the throttle valve.

4. An internal combustion engine as set forth in claim 3, wherein the throttle valve is of the butterfly type and is rotatable about an axis that passes through the induction system and the circumferentially spaced apertures are not parallel to said axis.

5. An internal combustion engine as set forth in claim 1, wherein there are a plurality of combustion chambers and the induction system generally cylindrical conduit portion is common to at least two of said combustion chambers.

6. An internal combustion engine as set forth in claim 5, wherein the induction system generally cylindrical conduit portion is common to all of the combustion chambers.

7. An internal combustion engine as set forth in claim 6, wherein the induction system includes at least one throttle valve for controlling flow and the mixing chamber is juxtaposed to said throttle valve.

8. An internal combustion engine as set forth in claim 7, wherein the mixing chamber is disposed downstream of the throttle valve.

9. An internal combustion engine as set forth in claim 8, further including a fuel system for delivering fuel to said engine for combustion in the combustion chambers, an evaporative fuel control system for preventing the emission of evaporated fuel from said fuel system to the atmosphere and an evaporative fuel control conduit communicating said evaporative fuel control system with said mixing chamber.

10. An internal combustion engine comprised of an engine body defining at least one combustion chamber, an induction system for delivering at least an air charge to said combustion chamber, said induction system including at least one generally cylindrical conduit portion, a fuel system for delivering fuel to said engine for combustion in said combustion chamber, and an evaporative fuel control system for preventing the emission of evaporated fuel from said fuel system to the atmosphere, said evaporative fuel control system including a mixing chamber encircling at least a portion of said induction system generally cylindrical conduit portion, a plurality of circumferentially spaced apertures in said induction system generally cylindrical conduit portion communicating said mixing chamber with the interior of said induction system generally cylindrical conduit portion and an evaporative fuel control conduit communicating said evaporative fuel control system with said mixing chamber.

11. An internal combustion engine as set forth in claim 10, wherein the induction system includes at least one throttle valve for controlling flow and the mixing chamber is juxtaposed to said throttle valve.

12. An internal combustion engine as set forth in claim 11, wherein the mixing chamber is disposed downstream of the throttle valve.

13. An internal combustion engine as set forth in claim 11, wherein the throttle valve is of the butterfly type and is rotatable about an axis that passes through the induction system and the circumferentially spaced apertures are not parallel to said axis.

14. An internal combustion engine as set forth in claim 10, wherein there are a plurality of combustion chambers and the induction system generally cylindrical conduit portion is common to at least two of said combustion chambers.

15. An internal combustion engine as set forth in claim 14, wherein the induction system generally cylindrical conduit portion is common to all of the combustion chambers.

16. An internal combustion engine as set forth in claim 15, wherein the induction system includes at least one throttle valve for controlling flow and the mixing chamber is juxtaposed to said throttle valve.

17. An internal combustion engine as set forth in claim 16, wherein the mixing chamber is disposed downstream of the throttle valve.
